(19) United States
(12) Patent Application Publication
(10) Pub. No.: US 2026/0204750 A1
(43) Pub. Date: Jul. 16, 2026

(54) SECONDARY BATTERY AND MANUFACTURING METHOD THEREOF

(71) Applicant: SK On Co., Ltd., Seoul (KR)

(72) Inventors: I Sak KIM, Daejeon (KR); Jung Hyun SEO, Daejeon (KR); Tae Gyun YU, Daejeon (KR); Seung Hun LEE, Daejeon (KR)

(21) Appl. No.: 19/445,624

(22) Filed: Jan. 12, 2026

(30) Foreign Application Priority Data
Jan. 13, 2025 (KR) 10-2025-0004948

(51) Int. Cl. H01M 50/536; B23K 26/21; B23K 26/323; H01M 50/103; H01M 50/533; H01M 50/548; H01M 50/586; H01M 50/59; B23K 101/36

(52) U.S. Cl. CPC H01M 50/536; B23K 26/21; B23K 26/323; H01M 50/103; H01M 50/533; H01M 50/548; H01M 50/586; H01M 50/59; B23K 2101/36

(57) ABSTRACT

Proposed are a secondary battery and a manufacturing method thereof. The battery includes a casing having an internal accommodation space, a plurality of electrode assemblies accommodated inside the casing, each including a positive electrode tab and a negative electrode tab, with tabs of the same polarity arranged in the same direction, a connection part configured to provide a structure in which the electrode assemblies are electrically connected in series through the casing, a positive terminal connected to a positive electrode tab of one of the electrode assemblies through the series connection structure and exposed outside the casing, and a negative terminal connected to a negative electrode tab of another one of the electrode assemblies through the series connection structure and exposed outside the casing.

### CROSS REFERENCE TO RELATED APPLICATION

The present application claims priority to Korean Patent Application No. 10-2025-0004948, filed January 13, 2025, the entire contents of which is incorporated herein for all purposes by this reference.

### BACKGROUND

### Technical Field

The present disclosure relates to a secondary battery and a manufacturing method thereof.

### Description of the Related Art

Secondary batteries are widely used as power sources for portable electronic devices and are used in series or parallel configurations for hybrid and electric vehicles.

In general, an electrode assembly including a positive electrode, a negative electrode, and a separator is accommodated in a packaging material, and an electrolyte is injected therein to form a single battery cell.

Connecting battery cells in series increases the total voltage, but this can lead to space constraints by requiring a large space relative to the required voltage, or the achievable voltage may be limited depending on the structural configuration. Accordingly, research has been conducted on methods for increasing the voltage of a battery cell itself and on methods for securing the stability of battery cells having high voltage.

### SUMMARY

According to an aspect of the present disclosure, provided are a secondary battery in which electrode assemblies are connected in series with a simple structure and method, and a manufacturing method of the secondary battery.

According to another aspect of the present disclosure, provided are a secondary battery that can be widely applied in green technology fields such as electric vehicles, battery charging stations, and other battery-based applications including solar power generation and wind power generation, and a manufacturing method of the secondary battery.

A secondary battery according to an embodiment of the present disclosure may include: a casing having an internal accommodation space; a plurality of electrode assemblies accommodated inside the casing, each including a positive electrode tab and a negative electrode tab, with tabs of the same polarity arranged in the same direction; a connection part configured to electrically connect the electrode assemblies in series through the casing; a positive terminal connected to a positive electrode tab of one of the electrode assemblies through the series connection structure and exposed outside the casing; and a negative terminal connected to a negative electrode tab of another one of the electrode assemblies through the series connection structure and exposed outside the casing.

In this case, the casing may be provided as a hexahedral-shaped conductive material.

In addition, the connection part may be formed by bending a positive electrode tab or a negative electrode tab, which is not connected to the positive terminal or the negative terminal, so that the positive electrode tab or the negative electrode tab is connected to an inner wall of the casing.

In addition, the connection part may be fixedly coupled to the inner wall of the casing by laser welding.

In addition, the connection part may further include an intermediate member provided on the inner wall of the casing corresponding to the negative electrode tab to improve a dissimilar material welding strength between the negative electrode tab and the casing.

In addition, the battery may further include an insulating member disposed between the electrode assembly and the connection part to prevent an internal short circuit.

In addition, the insulating member may be made of a non-conductive material.

In addition, the insulating member may be made of an elastomer capable of elastic deformation.

In addition, the insulating member may be provided as a composite material including polycarbonate and glass fiber.

In addition, the insulating member may be disposed on a side opposite to a casing inlet through which the electrode assemblies are inserted, and may be installed at a position corresponding to the tab not connected to the positive terminal or the negative terminal.

A manufacturing method of secondary battery according to another embodiment of the present disclosure may include: aligning a plurality of electrode assemblies each having a positive electrode tab and a negative electrode tab such that tabs of the same polarity are arranged in the same direction; inserting the plurality of electrode assemblies into a casing; forming, outside the casing, a positive terminal connected to a positive electrode tab of one of the electrode assemblies, and forming, outside the casing, a negative terminal connected to a negative electrode tab of another one of the electrode assemblies; and connecting the electrode assemblies in series by bending a remaining positive electrode tab and a remaining negative electrode tab after forming the terminals, and connecting the bent tabs to an inner wall of the casing.

In addition, an insulating member may be installed for preventing an internal short circuit between the electrode assembly and the bent positive electrode tab, or between the electrode assembly and the bent negative electrode tab.

In addition, among the insulating members, an insulating member positioned farther from a casing inlet through which the electrode assemblies are inserted may be pre-installed inside the casing at a position corresponding to the tab that is not connected to the positive terminal or the negative terminal, prior to the inserting of the plurality of electrode assemblies.

In addition, the bent positive electrode tab or the bent negative electrode tab may be fixedly coupled to the inner wall of the casing by laser welding.

In addition, an intermediate member may be installed on the inner wall of the casing to improve welding strength between the bent negative electrode tab and the inner wall of the casing, which are made of dissimilar materials.

The features and advantages of the present disclosure will become more apparent from the following detailed description based on the accompanying drawings.

Prior to this, terms or words used in this specification and claims should not be construed in their usual, dictionary meaning, and should be interpreted with meaning and concept consistent with the technical idea of the present disclosure on the basis of the principle that the inventor can define terminology appropriately to explain his or her invention in the best way possible.

According to an embodiment of the present disclosure, by presenting a series connection structure of electrode assemblies using a simple structure and method, high-voltage characteristics of a secondary battery can be improved.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a schematic side view showing a secondary battery according to an embodiment of the present disclosure;

FIG. 2 is an enlarged view showing portion “A” of FIG. 1;

FIG. 3 is an enlarged view showing portion “B” of FIG. 1;

FIG. 4 is a flowchart showing a method of manufacturing a secondary battery according to another embodiment of the present disclosure;

FIG. 5 is a reference view showing a process of inserting a plurality of electrode assemblies into a casing; and

FIG. 6 is a reference view showing a state in which terminals are formed outside the casing while the electrode assemblies are inserted into the casing, and the electrode assemblies are connected in series with the casing.

### DETAILED DESCRIPTION

Terms used to describe an embodiment of the present disclosure are not intended to limit the disclosure. It should be noted that singular expressions include plural expressions unless the context clearly dictates otherwise.

It should be noted that, in assigning reference numerals to components in the drawings, identical components are assigned the same reference numerals as much as possible even if they are shown in different drawings, and similar reference numbers are assigned to similar components.

The drawings may be schematic or exaggerated for the purpose of illustrating the embodiments. In this document, expressions such as “have”, “may have”, “include”, or “may include” refer to the presence of the corresponding feature (e.g., a numerical value, function, operation, or component such as a part), and do not exclude the presence of additional features.

Terms such as “one”, “other”, “another”, “first”, “second”, etc., are used to distinguish one component from another component, and the components are not limited by the terms.

Hereinafter, an embodiment of the present disclosure will be described in detail with reference to the attached drawings.

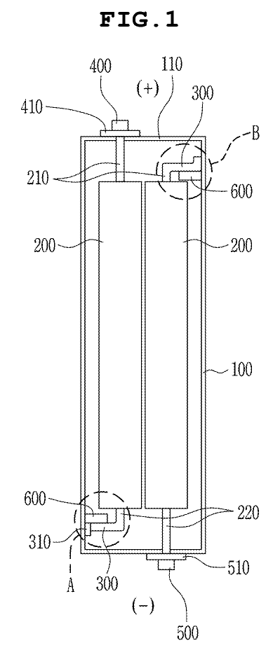

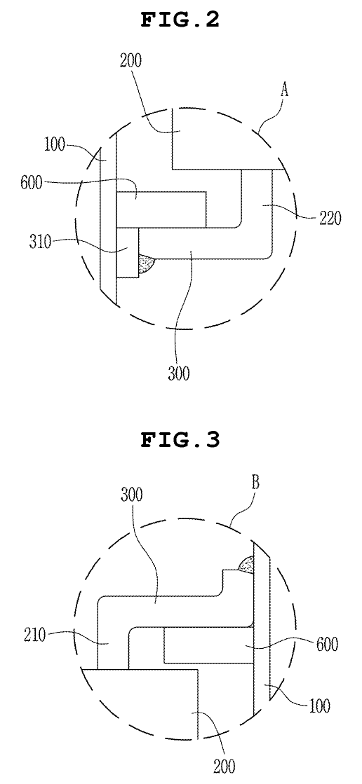

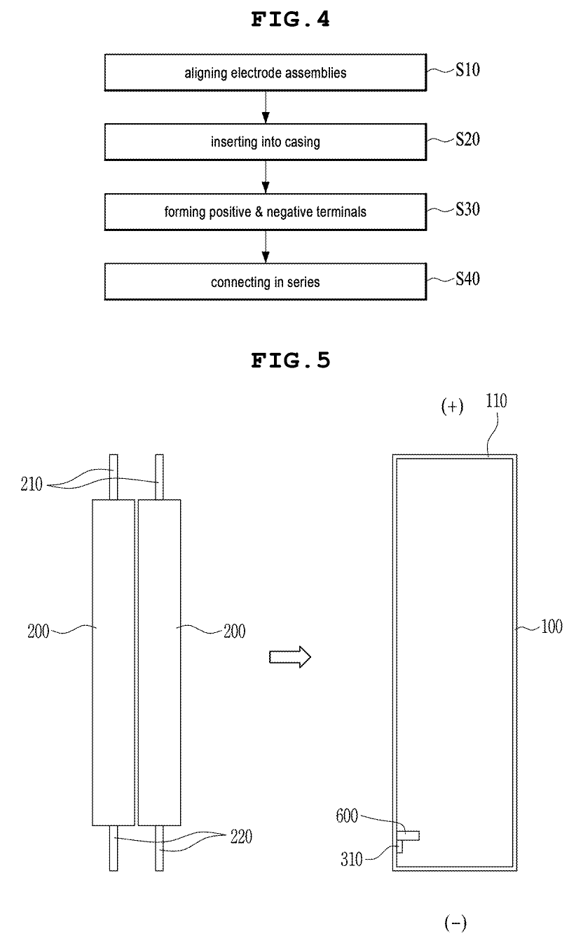

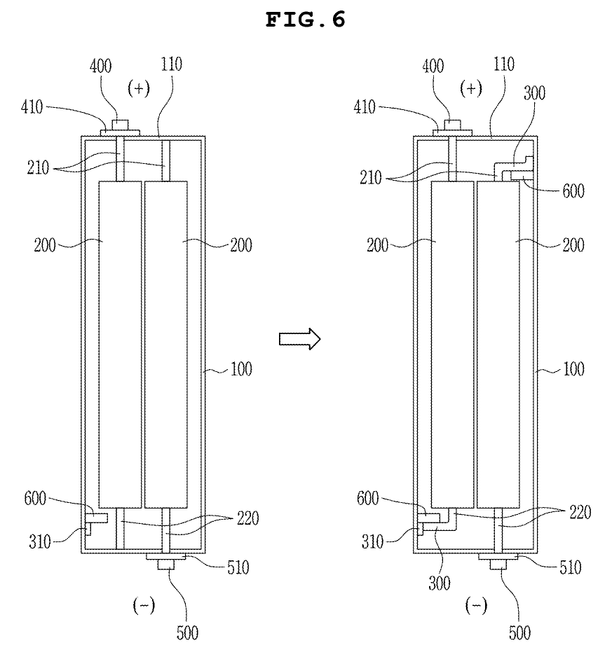

FIG. 1 is a schematic side view showing a secondary battery according to an embodiment of the present disclosure; FIG. 2 is an enlarged view showing portion “A” of FIG. 1; FIG. 3 is an enlarged view showing portion “B” of FIG. 1; FIG. 4 is a flowchart showing a method of manufacturing a secondary battery according to another embodiment of the present disclosure; FIG. 5 is a reference view showing a process of inserting a plurality of electrode assemblies into a casing; and FIG. 6 is a reference view showing a state in which terminals are formed outside the casing while the electrode assemblies are inserted into the casing, and the electrode assemblies are connected in series with the casing.

A secondary battery according to an embodiment of the present disclosure may include: a casing 100 having an internal accommodation space; a plurality of electrode assemblies 200 accommodated inside the casing 100, each including a positive electrode tab 210 and a negative electrode tab 220, with tabs of the same polarity arranged in the same direction; a connection part 300 configured to electrically connect the electrode assemblies 200 in series through the casing 100; a positive terminal 400 connected to the positive electrode tab 210 of one of the electrode assemblies 200 through the series connection structure and exposed outside the casing 100; and a negative terminal 500 connected to the negative electrode tab 220 of another one of the electrode assemblies 200 through the series connection structure and exposed outside the casing 100.

As illustrated in FIG. 1, the accommodation space may be formed inside the casing 100 to receive the electrode assemblies 200. The size of the accommodation space in the casing 100 may be determined in consideration of the size and number of electrode assemblies 200 to be accommodated therein.

In this case, the casing 100 may be provided as a conductive material having a hexahedral shape.

The casing 100 may be a rectangular or cubic prism with a square cross-section and may be provided as a hollow structure to form the internal accommodation space. In addition, the casing 100 may be made of a conductive material that allows electrical connection in series with the electrode assemblies 200.

In the secondary battery according to the present disclosure, a single casing 100 may be applied, and in case that two or more casings 100 are provided as needed, the casings 100 may be connected to each other to maintain a short-circuit state.

The electrode assembly 200 may be accommodated inside the casing 100, and the plurality of electrode assemblies 200 may be provided to be inserted into the casing 100 so as to have a series connection structure inside the casing 100. Each of the electrode assemblies 200 may include the positive electrode tab 210 and the negative electrode tab 220.

As shown in FIG. 1, at opposite ends of individual electrode assemblies 200, positive electrode tabs 210 and negative electrode tabs 220 protruding outward from the electrode assemblies 200 may be provided.

In this case, the plurality of electrode assemblies 200 may be arranged so that tabs of the same polarity are positioned in the same direction. That is, in the plurality of electrode assemblies 200, the positive electrode tabs 210 may be disposed on one side of the electrode assemblies 200, while the negative electrode tabs 220 may be disposed on the opposite side.

The connection part 300 may provide a series connection structure in which the electrode assemblies 200 are electrically connected in series through the casing 100 made of a conductive material.

In this case, the connection part 300 may be formed by bending so that the negative electrode tab 220 or the positive electrode tab 210, which is not connected to the positive terminal 400 or the negative terminal 500, is connected to the inner wall of the casing 100.

To be specific, the connection part 300 may be defined as the negative electrode tab 220 or positive electrode tab 210 that is bent through bending processing so as to connect the remaining negative electrode tab 220 or positive electrode tab 210 of the electrode assemblies 200, which is not connected to the positive terminal 400 or the negative terminal 500, to the inner wall of the casing 100.

In other words, the positive electrode tab 210 or negative electrode tab 220 provided at opposite ends of the individual electrode assembly 200 remains as the positive electrode tab 210 or negative electrode tab 220 before bending. However, when bent through bending processing, the positive electrode tab 210 or negative electrode tab 220 may be considered as the connection part 300.

Meanwhile, the positive terminal 400 may be formed to be electrically connected to the positive electrode tab 210 of any one of the electrode assemblies 200 and exposed outside the casing 100.

In addition, the negative terminal 500 may be formed to be electrically connected to the negative electrode tab 220 of another one of the electrode assemblies 200 and exposed outside the casing 100.

For example, as shown in FIG. 1, in the present disclosure, when two electrode assemblies 200 are provided, the positive electrode tab 210 of one of the two electrode assemblies 200 may be electrically connected to the positive terminal 400, and the negative electrode tab 220 of the other electrode assembly 200 may be electrically connected to the negative terminal 500.

The positive terminal 400 may be formed on one side of the casing 100, and the negative terminal 500 may be formed on the opposite side of the casing 100. In this case, the positive terminal 400 and the negative terminal 500 may be insulated from the casing 100 by insulators 410 and 510, respectively.

The connection part 300 may be fixedly coupled to the inner wall of the casing 100 by laser welding.

The bent positive electrode tab 210 and negative electrode tab 220 may each serve as the connection part 300, which can be electrically connected to the inner wall of the casing 100 by laser welding.

The remaining positive electrode tab 210 and negative electrode tab 220 of the electrode assemblies 200, which are not connected to the positive terminal 400 and the negative terminal 500, may be bent to form the connection part 300. The connection part 300 is electrically connected to the casing 100, made of a conductive material, by laser welding, thereby allowing the plurality of electrode assemblies 200 to be connected in series through the casing 100.

The connection part 300 may further include an intermediate member 310 provided on the inner wall of the casing 100 corresponding to the negative electrode tab 220 to improve the dissimilar material welding strength between the negative electrode tab 220 and the casing 100.

As shown in FIG. 2, the intermediate member 310 may be provided to facilitate welding between the negative electrode tab 220 and the casing 100, which are made of different materials, and to improve the welding quality and strength after welding.

For reference, the negative electrode tab 220 is typically made of copper (Cu), whereas the casing 100 may be made of aluminum (Al). Welding such dissimilar materials is difficult, and it is challenging to maintain sufficient welding strength afterward. Thus, the separate intermediate member 310 may be used to facilitate welding between the dissimilar materials.

For example, copper and aluminum are metals with different physical and chemical properties. When directly welding these dissimilar materials, differences in thermal conductivity, melting point, and thermal expansion coefficient can cause thermal stress or uneven cooling, and brittle compounds may form at the joint.

By using the intermediate member 310, chemical compatibility between the dissimilar materials can be provided. The intermediate member 310 provides suitable compatibility when joining dissimilar materials, thereby suppressing reactions between the dissimilar materials and enabling stable bonding. In addition, the intermediate member 310 may mitigate differences in the thermal expansion coefficients between the dissimilar materials, preventing deformation or cracking due to thermal stress, and enhancing the strength of the joint surface to improve mechanical performance.

As shown in FIG. 2, the intermediate member 310 may be provided on the inner wall of the casing 100 corresponding to the negative electrode tab 220 of the connection part 300. The intermediate member 310 may be pre-installed on the corresponding position of the inner wall of the casing 100 to facilitate welding. In this case, the material of the intermediate member 310 may be selectively determined in consideration of the materials of the dissimilar materials. For example, when the negative electrode tab 220 is made of copper and the casing 100 is made of aluminum, the intermediate member 310 may be made of a material including at least one of zinc, silver, or nickel.

For reference, as shown in FIG. 3, the connection part 300 formed by the bent positive electrode tab 210 may not include the intermediate member 310. Since the positive electrode tab 210 is typically made of aluminum, the same material as the casing 100, welding can be performed by a conventional method without using the intermediate member 310.

Meanwhile, the secondary battery according to the present disclosure may further include an insulating member 600 disposed between the electrode assembly 200 and the connection part 300 to prevent internal short circuit.

As shown in FIGS. 2 and 3, the insulating member 600 may be disposed between the electrode assembly 200 and the connection part 300. As shown in FIG. 2, the insulating member 600 may be provided between the connection part 300 formed by the bent negative electrode tab 220 and the electrode assembly 200, and as shown in FIG. 3, may also be provided between the connection part 300 formed by the bent positive electrode tab 210 and the electrode assembly 200 to prevent internal short circuits caused by swelling or damage of the electrode assembly 200.

Accordingly, the insulating member 600 may be made of a non-conductive material.

By providing the insulating member 600 made from a non-conductive material, even if the electrode assembly 200 swells of damaged, the insulating member 600 disposed between the electrode assembly 200 and the connection part 300 prevents direct contact between the electrode assembly 200 and the connection part 300.

In this case, the insulating member 600 may be made of an elastomer capable of elastic deformation.

By providing the insulating member 600 as an elastomer, when the electrode assembly 200 swells of damaged, the insulating member 600 may elastically deform to prevent direct contact between the electrode assembly 200 and the connection part 300. In addition, the insulating member 600 may be made of a material with excellent chemical resistance to maintain against chemicals such as electrolytes, and may be provided as a high-strength material.

Accordingly, the insulating member 600 may be provided as a composite material including polycarbonate and glass fiber.

By providing the insulating member 600 as a composite material including polycarbonate and glass fiber, the insulating member 600 may be non-conductive, elastically deformable, chemically resistant, and have sufficient strength and stiffness.

In this case, the glass fiber may be included at a proportion of 10 to 30% of the total composition. When the glass fiber is present at 10 to 30%, the insulating member 600 has the advantage of excellent processability and surface quality. In case that the proportion falls outside this range, the processability and surface quality may be limited.

In this case, the insulating member 600 may be pre-installed on the inner wall of the casing opposite to a casing inlet 110 into which the electrode assembly 200 is inserted.

Referring to FIG. 1, a plurality of insulating members 600 may be provided inside the casing 100. The insulating member 600 may be installed to be positioned between the electrode assembly 200 and the connection part 300 after inserting the plurality of electrode assemblies 200 into the casing 100. However, to improve installation convenience and reduce manufacturing time, insulating members 600 at specific locations may be pre-installed inside the casing 100.

The insulating member 600 that can be pre-installed inside the casing 100 may be positioned on the inner wall of the casing 100 opposite to the casing inlet 110, that is, on the side farthest from the casing inlet 110 into which the electrode assembly 200 is inserted. At this time, the insulating member 600 may be pre-installed at a position corresponding to the tab (bent positive electrode tab 210 or negative electrode tab 220) that is not connected to the positive terminal 400 or negative terminal 500.

Hereinafter, with reference to FIGS. 4 to 6, a manufacturing method of a secondary battery according to another embodiment of the present disclosure will be described.

As shown in FIG. 4, the manufacturing method of a secondary battery according to another embodiment of the present disclosure will be described may include: an electrode assembly alignment step S10 in which a plurality of electrode assemblies 200 with positive electrode tabs 210 and negative electrode tabs 220 is aligned such that tabs of the same polarity are arranged in the same direction; an insertion step S20 in which the plurality of electrode assemblies 200 is inserted into a casing 100; a terminal formation step S30 in which a positive terminal 400 connected to a positive electrode tab 210 of one of the plurality of electrode assemblies 200 is formed outside the casing 100, and a negative terminal 500 connected to a negative electrode tab 220 of another of the plurality of electrode assemblies 200 is formed outside the casing 100; and a series connection step S40 in which a remaining positive electrode tab 210 and a remaining negative electrode tab 220 are bent, and connected to the inner wall of the casing 100 so that the electrode assemblies 200 are electrically connected in series.

The electrode assembly alignment step S10 may refer to a process of arranging a plurality of electrode assemblies 200, each having a positive electrode tab 210 and a negative electrode tab 220 at opposite ends, so that tabs of the same polarity are aligned in the same direction.

As shown in FIG. 5, according to the electrode assembly alignment step S10, the plurality of electrode assemblies 200 may be arranged so that tabs of the same polarity (i.e., positive electrode tabs 210 or negative electrode tabs 220) are positioned in the same direction.

Thus, for example, as shown in FIG. 5, when the positive electrode tab 210 is positioned on one side of the electrode assembly 200, the negative electrode tab 220 may be positioned on the other side. At this time, the positive electrode tab 210 or the negative electrode tab 220 may be extended in a straight configuration parallel to the electrode assembly 200.

The insertion step S20 S10 may refer to a process of inserting the plurality of electrode assemblies 200, aligned as described above, into the casing 100.

The plurality of electrode assemblies 200 may be inserted into the interior of the casing 100 through a casing inlet 110 formed on one side of the casing 100. At this time, an insulating member 600 and an intermediate member 310 may be pre-installed inside the casing 100, which will be described in more detail later.

As shown in FIG. 6, the terminal formation step S30 may refer to a process of forming a positive terminal 400, connected to a positive electrode tab 210 of one of the electrode assemblies 200 inserted into the casing 100, on one exterior side of the casing 100.

In addition, the terminal formation step S30 may refer to a process of forming a negative terminal 500, connected to a negative electrode tab 220 of another one of the electrode assemblies 200 inserted into the casing 100, on the other exterior side of the casing 100.

The positive terminal 400 and the negative terminal 500 may be formed to be exposed outside the casing 100 and may be insulated from the casing 100 by insulators 410 and 510, respectively.

The series connection step S40 may refer to a process of forming a connection part 300 by bending a remaining positive electrode tab 210 and a remaining negative electrode tab 220, which are not connected to the positive terminal 400 and the negative terminal 500, respectively.

In addition, the series connection step S40 may include a process in which the bent positive electrode tab 210 and negative electrode tab 220, that is, the respective connection parts 300, are electrically connected to the inner wall of the casing 100 made of a conductive material by laser welding, so that the electrode assemblies 200 inside the casing 100 are electrically connected to each other in series.

In this case, the insulating member 600 for preventing internal short circuits may be installed between the electrode assembly 200 and the bent positive electrode tab 210, and between the electrode assembly 200 and the bent negative electrode tab 220.

The plurality of insulating members 600 may be installed even after the electrode assemblies 200 are inserted into the casing 100. However, insulating members 600 at specific positions that do not interfere with or obstruct the insertion process of the electrode assemblies 200 into the casing 100 may be pre-installed to improve installation convenience and reduce manufacturing time.

Thus, among the insulating members 600, an insulating member 600 located far from the casing inlet 110 through which the electrode assemblies 200 are inserted may be pre-installed inside the casing 100 at a position corresponding to a tab that is not connected to the positive terminal 400 or the negative terminal 500, prior to the insertion step S20.

Referring to FIG. 5, among the plurality of insulating members 600, the insulating member 600 located far from the casing inlet 110, that is, on the side opposite to the casing inlet 110, may be pre-installed on the inner wall of the casing 100. The insulating member 600 may be installed at a position corresponding to a tab not connected to the positive terminal 400 or the negative terminal 500, that is, the bent positive electrode tab 210 or negative electrode tab 220 defined as the connection part 300.

Since the insulating member 600 has been described in detail in the above-described embodiment of the present disclosure, a detailed description thereof will be omitted herein.

Meanwhile, the bent positive electrode tab 210 or negative electrode tab 220 may be fixedly coupled to the inner wall of the casing 100 by laser welding.

In the electrode assemblies 200 inserted into the casing 100, during the series connection step S40, the remaining positive electrode tab 210 and negative electrode tab 220, which are not connected to the positive terminal 400 or the negative terminal 500 are bent to face the inner wall of the casing 100. The positive electrode tab 210 or negative electrode tab 220 bent in this manner may be fixedly coupled to the casing 100 by laser welding.

In this case, to improve the dissimilar material welding strength between the bent negative electrode tab 220 and the inner wall of the casing 100, the intermediate member 310 may be installed on the inner wall of the casing 100.

The intermediate member 310 may be installed at a specific point on the inner wall of the casing 100 corresponding to the bent negative electrode tab 220. As shown in FIG. 5, when a specific insulating member 600 is pre-installed inside the casing 100, the intermediate member 310 may also be pre-installed at the corresponding point.

Above, the present disclosure has been described in detail through specific embodiments. The embodiments are for specifically explaining the present disclosure, and are only illustrative and do not limit the scope of the appended claims. It is obvious to those skilled in the art that various changes and modifications to the embodiments are possible within the scope and technical idea of the present disclosure, and it is natural that such changes and modifications fall within the scope of the appended claims.

What is claimed is:

1. A secondary battery comprising:
a casing having an internal accommodation space;
a plurality of electrode assemblies accommodated inside the casing, each comprising a positive electrode tab and a negative electrode tab, with tabs of the same polarity arranged in the same direction;
a connection part configured to provide a structure in which the electrode assemblies are electrically connected in series through the casing;
a positive terminal connected to a positive electrode tab of one of the electrode assemblies through the series connection structure and exposed outside the casing; and
a negative terminal connected to a negative electrode tab of another one of the electrode assemblies through the series connection structure and exposed outside the casing.

2. The battery of claim 1, wherein the casing is provided as a hexahedral-shaped conductive material.

3. The battery of claim 1, wherein the connection part is formed by bending a positive electrode tab or a negative electrode tab, which is not connected to the positive terminal or the negative terminal, so that the positive electrode tab or the negative electrode tab is connected to an inner wall of the casing.

4. The battery of claim 3, wherein the connection part is fixedly coupled to the inner wall of the casing by laser welding.

5. The battery of claim 3, wherein the connection part further comprises an intermediate member provided on the inner wall of the casing corresponding to the negative electrode tab to improve a dissimilar material welding strength between the negative electrode tab and the casing.

6. The battery of claim 1, further comprising:
an insulating member disposed between the electrode assembly and the connection part to prevent an internal short circuit.

7. The battery of claim 6, wherein the insulating member is made of a non-conductive material.

8. The battery of claim 7, wherein the insulating member is made of an elastomer capable of elastic deformation.

9. The battery of claim 8, wherein the insulating member is provided as a composite material including polycarbonate and glass fiber.

10. The battery of claim 6, wherein the insulating member is pre-installed on an inner wall of the casing opposite to a casing inlet through which the electrode assemblies are inserted.

11. A manufacturing method of a secondary battery, the method comprising:
aligning a plurality of electrode assemblies each having a positive electrode tab and a negative electrode tab such that tabs of the same polarity are arranged in the same direction;
inserting the plurality of electrode assemblies into a casing;
forming, outside the casing, a positive terminal connected to a positive electrode tab of one of the electrode assemblies, and forming, outside the casing, a negative terminal connected to a negative electrode tab of another one of the electrode assemblies; and
connecting the electrode assemblies in series by bending a remaining positive electrode tab and a remaining negative electrode tab after forming the terminals, and connecting the bent tabs to an inner wall of the casing.

12. The method of claim 11, wherein an insulating member is installed for preventing an internal short circuit between the electrode assembly and the bent positive electrode tab, or between the electrode assembly and the bent negative electrode tab.

13. The method of claim 12, wherein among the insulating members, an insulating member positioned farther from a casing inlet through which the electrode assemblies are inserted is pre-installed inside the casing at a position corresponding to the tab that is not connected to the positive terminal or the negative terminal, prior to the inserting of the plurality of electrode assemblies.

14. The method of claim 11, wherein the bent positive electrode tab or the bent negative electrode tab is fixedly coupled to the inner wall of the casing by laser welding.

15. The method of claim 13, wherein an intermediate member is installed on the inner wall of the casing to improve welding strength between the bent negative electrode tab and the inner wall of the casing, which are made of dissimilar materials.
